(19) United States
(12) Patent Application Publication
(10) Pub. No.: US 2013/0174675 A1
(43) Pub. Date: Jul. 11, 2013

(54) TELESCOPIC TEST BAR STRUCTURE

(71) Applicant: CHING-PIN CHEN, TAIPEI CITY (TW)

(72) Inventor: CHING-PIN CHEN, TAIPEI CITY (TW)

(73) Assignee: CHY FIREMATE CO., LTD., TAINAN CITY (TW)

(21) Appl. No.: 13/344,682

(22) Filed: Jan. 6, 2012

(51) Int. Cl. G01D 21/00

(52) U.S. Cl. 73/866.5

(57) ABSTRACT

A telescopic test bar structure comprises a circuit unit and a winding device within a main body, and a telescopic test bar connected externally to the main body. The winding device has a shaft, which has a slit provided at the center thereof, protruding from a housing. A reel disk is received within the housing. A receiving groove for winding a sensing wire is formed on the reel disk and an accommodation space for receiving an elastic element is formed on the reel disk. The inner end of the sensing wire is electrically connected with the circuit unit. A sensor element on the outer end of the sensing wire is connected to the telescopic test bar. This structure has the advantage of better operational convenience in extension and shortening of the test bar without wiring entanglement.

### BACKGROUND OF INVENTION

1. Field of the Invention

The present invention relates to a telescopic test bar structure, more particularly to a telescopic test bar structure which has the advantage of better operational convenience in extension and shortening of the test bar without any wiring entanglement.

2. Brief Description of Prior Art

Generally, in measurement of temperature, wind velocity or gas concentration, measurement personnel use various relevant measuring device to conduct measurement. Referring to FIG. 6 of a conventional structure, a measuring device (4) has a main machine (41) connected with a sensing wire (42). The sensing wire (42) is inserted into a telescopic test bar (43) and attached to the top end of the telescopic test bar (43). When the telescopic test bar (43) is extended outward, the sensing wire (42) within the telescopic test bar (43) is also extended outward so as to conduct relevant far-end or high-altitude measurement

The above measuring device can achieve predetermined effect of conducting relevant measurement, but it is found in practical implementation that the sensing wire, often in externally exposed state, is apt to get entangled with the other objects, even to cause bad sensing contact or breaking due to pulling and dragging when the telescopic test bar is collapsed. Hence, it is inconvenient in collapsing the test bar structure so that there are still rooms for improvement in its overall design.

In view of the above facts, the inventor of the present invention proposes a telescopic test bar structure according to the research and improvement conducted on the conventional structures and its disadvantages, based on his abundant experience of development and manufacturing in relevant fields, so as to achieve better practical value.

### SUMMARY OF INVENTION

The telescopic test bar structure of the present invention mainly comprises a circuit unit and a winding device within a main body, and a telescopic test bar connected externally to the main body. The winding device has a shaft, which has a slit provided at the center thereof, protruding from the inside of a housing. A first notch and a second notch are also provided on the outer edge of the housing. A reel disk having an axial bore, which corresponds to the shaft, at the center thereof, is received within the housing. A receiving groove is formed on the side edge of the reel disk and an accommodation space is formed on the side corresponding to the outer end of the shaft. An insertion gap is formed on the outer edge of the accommodation space. A sensing wire is wound around the receiving groove and the inner end of the sensing wire is electrically connected with the circuit unit through the first notch on the outer edge of the housing. A sensor element provided on the outer end of the sensing wire is inserted, through the second notch on the outer edge of the housing, into the interior of the telescopic test bar and attached to the top end thereof. A helical spring element is contained within the accommodation space of the reel disk in such a manner that the inner end of the helical spring element is inserted and locked in the outer end of the slit on the shaft protruding through the axial bore, while the outer end of the helical spring element being engaged in the insertion gap on the outer edge of the accommodation space of the reel disk. This structure has the advantage of better operational convenience in extension and shortening of the test bar without any wiring entanglement. Therefore, better performance can be achieved in its overall implementation.

### BRIEF DESCRIPTION OF THE DRAWINGS

FIG. 1 is a perspective exploded schematic view of the present invention.

FIG. 2 is a perspective exploded structural schematic view showing the winding device of the present invention.

FIG. 3 is an assembled sectional schematic view of the structure of the present invention.

FIG. 4 is a schematic view showing the state of usage of the present invention.

FIG. 5 is sectional structural schematic view showing the state of usage of the winding device of the present invention.

FIG. 6 is a structural schematic view of a prior art.

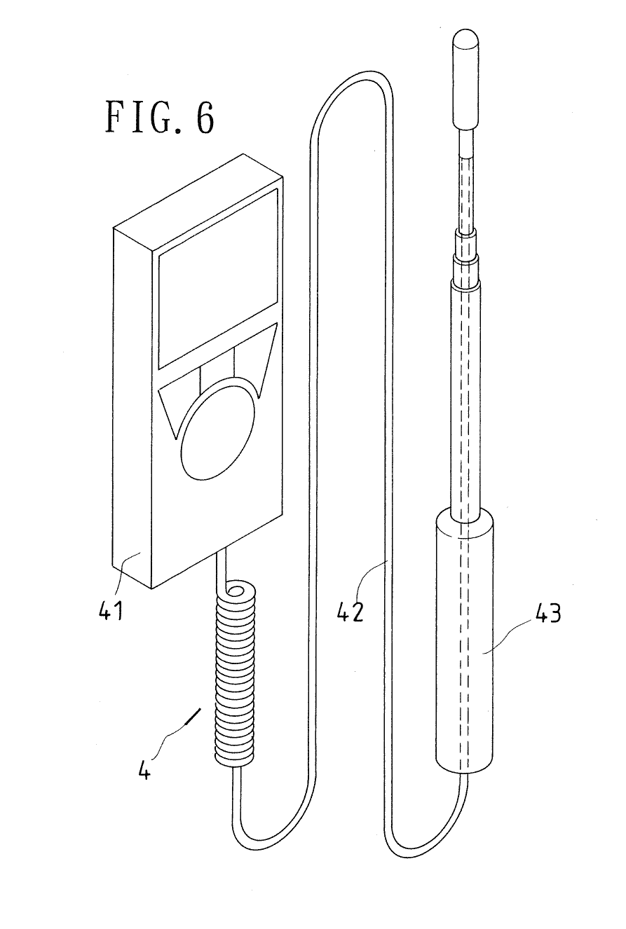

### DETAILED DESCRIPTION OF PREFERRED EMBODIMENTS

The objects, the technical contents and the expected effectiveness of the present invention will become more apparent from the detailed description of the preferred embodiment in conjunction with the accompanying drawings.

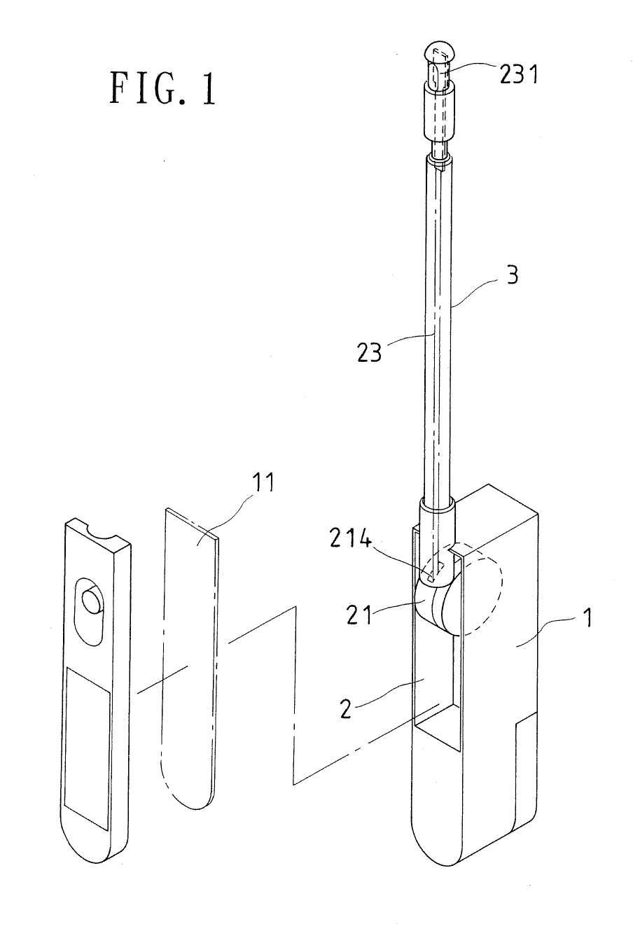

FIG. 1 is a perspective schematic exploded view showing the whole structure of the present invention. As shown in the figure, the telescopic test bar structure mainly comprises a circuit unit (11) and a winding device (2) within a main body (1), and a telescopic test bar (3) connected externally to the main body (1).

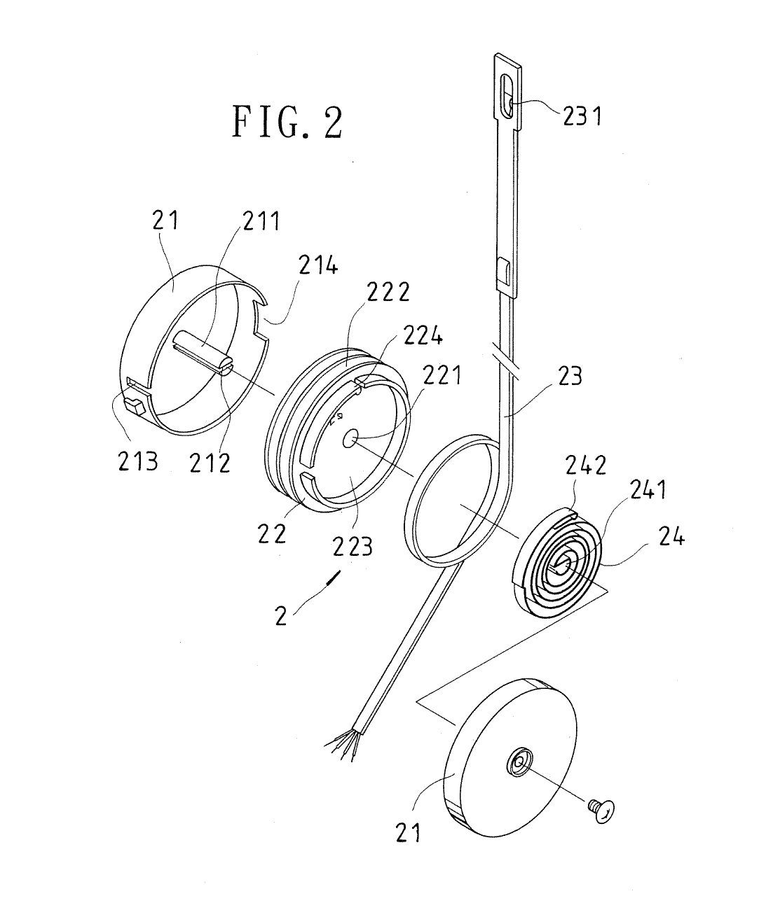

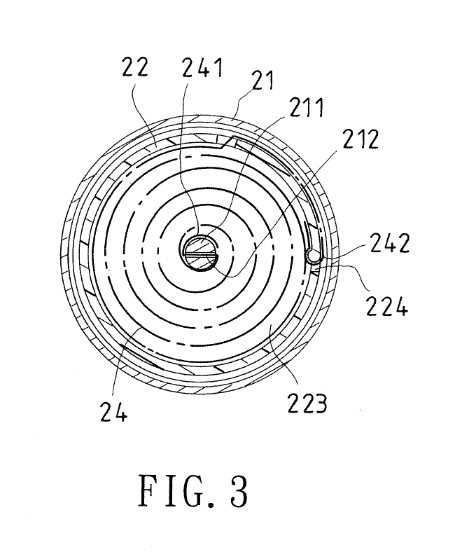

FIG. 2 is a perspective schematic exploded view showing the winding device (2) of the present invention. Also referring to FIG. 2, the winding device (2) has a shaft (211) attached to the inside of a housing (21). A slit (212) is provided at the center of the shaft (211), and a first notch (213) and a second notch (214) are provided on the outer edge of the housing (21). A reel disk (22) is received within the housing (21) by the fitting of an axial bore (221) provided at the center thereof with the corresponding shaft (211) of the housing (21). A receiving groove (222) is formed on the side edge of the reel disk (22) and an accommodation space (223) is formed on the side corresponding to the outer end of the shaft (211). An inserting gap (224) is formed on the outer edge of the accommodation space (223). A sensing wire (23) is wound around the receiving groove (222) and the inner end of the sensing wire (23) is electrically connected with the circuit unit (11) through the first notch (213) on the outer edge of the housing (21). A sensor element (231) provided on the outer end of the sensing wire (23) is inserted, through the second notch (214) on the outer edge of the housing (21), into the interior of the telescopic test bar (3) and attached to the top end thereof. A helical spring element (24) is contained within the accommodation space (223) of the reel disk (22) in such a manner that the inner end (241) of the helical spring element (24) is inserted and locked in the outer end of the slit (212) on the shaft (211) protruding from the axial bore (221), while the outer end (242) of the helical spring element (24) being engaged in the insertion gap (224) on the outer edge of the accommodation space (223) of the reel disk (22), as shown in FIG. 3.

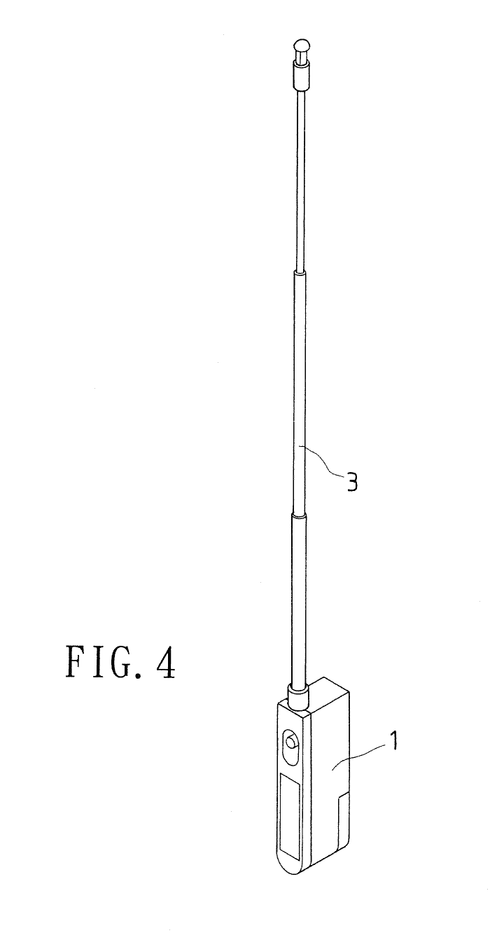

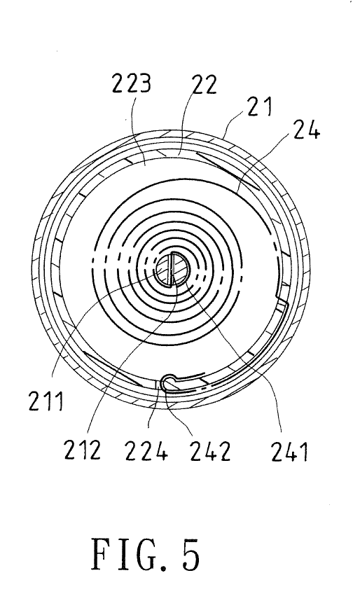

FIG. 4 is a schematic view showing the state of usage of the present invention. In operation, the present invention is mainly for far-end or high-altitude measurement. As shown in this figure, when the telescopic test bar (3) is drawn outward, the sensor element (231) connected to the top end of the telescopic test bar (3) is also drawn outward together with the sensing wire (23). Accompanying with the draw-out of the sensing wire (23), the reel disk (22) on which the sensing wire (23) is wound is pulled to rotate. As both ends of the helical spring element (24) are respectively locked between the shaft (211) and the outer edge of the accommodation space (223), the helical spring element (24) received within the accommodation space (223) is wound up to become stronger in elastic force along with the rotation of the reel disk (22), as shown in FIG. 5. In this manner, the sensor element (231) attached to the top end of the telescopic test bar (3) can conduct test in stable manner. After finishing the test, the telescopic test bar (3) is pushed inward to become shortened so that the helical spring element (24) carries the reel disk (22) to rotate by its elastic restoring force, and the sensing wire (23) is rewound around the receiving groove (222) of the reel disk (22).

Based on foregoing structural constitution and implementation of the present invention, the telescopic test bar structure of the present invention has the advantage of better operational convenience in extension and shortening of the test bar without any wiring entanglement. Therefore, better performance can be achieved in its overall implementation.

The above embodiment and the accompanying drawings are not intended to restrict the structural aspect of the present invention. Variations or modifications conducted by the person skilled in the art without departing from the spirit and scope of the present invention should be considered to be within the scope of the present invention.

What is claimed is:

1. A telescopic test bar structure, mainly comprising a circuit unit and a winding device within a main body and a telescopic test bar connected externally to the main body, wherein:
said winding device has a shaft, which has a slit provided at the center thereof, protruding from the inside of a housing; a first notch and a second notch being provided on the outer edge of said housing; a reel disk being received within said housing, said reel disk having an axial bore, which corresponds to said shaft, provided at the center thereof; a receiving groove being formed on the side edge of said reel disk and an accommodation space being formed on the side corresponding to the outer end of said shaft; an insertion gap being formed on the outer edge of said accommodation space; a sensing wire being wound around said receiving groove, the inner end of said sensing wire being electrically connected with said circuit unit through said first notch on the outer edge of said housing; a sensor element provided on the outer end of said sensing wire being inserted, through said second notch on the outer edge of said housing, into the interior of said telescopic test bar and attached to the top end thereof; a helical spring element being contained within said accommodation space of said reel disk in such a manner that the inner end of said helical spring element is inserted and locked in the outer end of said slit of said shaft protruding through said axial bore, while the outer end of said helical spring element being engaged in said insertion gap on the outer edge of said accommodation space of said reel disk.
